(19) United States
(12) Patent Application Publication
(10) Pub. No.: US 2023/0202897 A1
(43) Pub. Date: Jun. 29, 2023

(54) A PROCESS FOR ACCELERATING BIOLOGICAL DECOMPOSITION OF ORGANIC COMPOUNDS

(71) Applicant: DR. POOPER ENTERPRISES LLC, Hockly, TX (US)

(72) Inventor: Alan L. Rein, Hockly, TX (US)

(73) Assignee: DR. POOPER ENTERPRISES LLC, Hockly, TX (US)

(21) Appl. No.: 17/928,266

(22) PCT Filed: May 28, 2021
(86) PCT No.: PCT/US2021/034896

§ 371 Date: Nov. 28, 2022

Related U.S. Application Data
(60) Provisional application No. 63/031,396, filed on May 28, 2020.

(51) Int. Cl. C02F 11/04; C02F 11/02

(52) U.S. Cl. CPC C02F 11/04; C02F 11/02; C02F 2305/06; C02F 2303/02; C02F 2103/20

(57) ABSTRACT

Biological decomposition of organic compounds where the organic compounds are part of an aqueous admixture can be accelerated by introducing a bio-accelerant into the admixture. The bio-accelerant can be prepared by combining a first compound selected from the group consisting of, alkali metal formates, alkali metal acetates, alkali metal malonates, alkali metal nitrates, alkali metal adipates, alkali metal salts of propane-1, 2,3-tricarboxylic acid, and alkali metal citrates; and a second compound selected from the group consisting of: alkali metal carbonates, alkali metal bicarbonates, alkali metal dimethyl carbonates, and alkali metal hypochlorites.

### BACKGROUND OF THE INVENTION

### 1. Field of the Invention

The invention relates to biological decomposition of organic compounds. The invention particularly relates to accelerating biological decomposition of organic compounds.

### 2. Background of the Art

Organic compounds, often in the form of sludge, have historically been and continue to be a problem in the treatment of waste liquids. For example, U.S. Pat. No. 3,156,646, which is incorporated herein by reference in its entirety, discloses that many processes and a large variety of apparatus have been developed for the digestion of basically raw sewage such as that discharged into municipal sewage systems. This reference goes on to detail issues relating to treating solids removed from such systems as compared to treating the raw wastewater derived from human waste.

The reduction of biological sludge occurs in other applications besides treating human waste. Organic sludges can occur with industrial wastewater systems, agricultural wastewater systems, and especially with animal husbandry-based wastewater systems.

What all of these systems have in common is the employment of bacteria and other microscopic flora to reduce the sludges ultimately to carbon dioxide and/or methane. For example, it is a common practice in some applications to simply dehydrate sludges and bury them. Sometimes the sludges are instead burned as fuel.

While effective, such applications tend to be expensive and to require extensive handling. Mishandling of such systems can result in spills and other forms of environmental contamination.

It is often difficult and expensive to introduce sufficient oxygen into sludges to allow microscopic flora to efficiently break down or decompose such materials.

It would be desirable in the art to be able to accelerate the activity of bacteria and other microscopic flora in breaking down organic compounds. It would be especially desirable if such acceleration could occur with the treatment of biological sludges.

### SUMMARY OF THE INVENTION

In one aspect, the invention is a process for accelerating biological decomposition of organic compounds comprising: introducing a bio-accelerant into an aqueous admixture of the organic compounds wherein the bio-accelerant comprises: a first compound selected from the group consisting of, alkali metal formates, alkali metal acetates, alkali metal malonates, alkali metal nitrates, alkali metal adipates, alkali metal salts of propane-1,2,3-tricarboxylic acid, or alkali metal citrates; and a second compound selected from the group consisting of: alkali metal carbonates, alkali metal bicarbonates, alkali metal dimethyl carbonates, or alkali metal hypochlorites.

In another aspect, the invention is such a process wherein the first and second compounds are combined to form the bio-accelerant, and the bio-accelerant is introduced into the admixture at a concentration of from about 5 parts per million to about 25,000 parts per million.

In still another aspect, the invention is a process as described above wherein the bio-accelerant also includes a bacteria culture selected for an intended end-use.

### BRIEF DESCRIPTION OF THE DRAWINGS

The above and other features and advantages of the present invention will become more apparent by describing in detail embodiments thereof with reference to the attached drawings in which:

FIG. 1 is a photomicrograph of the control after one hour;

FIG. 2 is a photomicrograph of the test sample after one hour;

FIG. 3 is a photomicrograph of the control after one day; and

FIG. 4 is a photomicrograph of the test sample after one day.

### DESCRIPTION OF THE PREFERRED EMBODIMENTS

In one embodiment, the invention is a process for accelerating biological decomposition of organic compounds in aqueous admixtures. It does not matter what the origin of the biological compounds is, the only limiting factor to the embodiments of the present application is that the organic compounds are those that can be treated biologically. For example, the biological compounds can result from the treatment of human waste, agricultural production, animal husbandry, and the like.

The processes of the present application are particularly useful when the organic compounds are in the form of an aqueous sludge. Desirably, the sludge can be reduced in volume in an amount sufficient to reduce or even eliminate the need to remove and dispose of it.

Biological decomposition is achieved in the process of the present application by introducing a bio-accelerant into the aqueous admixtures. In one embodiment, the bio-accelerant comprises: a first compound selected from the group consisting of alkali metal formates, alkali metal acetates, alkali metal malonates, alkali metal nitrates alkali metal adipates, alkali metal salts of propane-1,2,3-tricarboxylic acid, or alkali metal citrates; and a second compound selected from the group consisting of: alkali metal carbonates, alkali metal bicarbonates, alkali metal dimethyl carbonates, or alkali metal hypochlorites.

In the practice of the process of the application, the bio-accelerant may be prepared by admixing the first compound with the second compound. For the purposes the present application, the term “admixing” means combining the 2 materials into an apparent single phase. For example, one form of admixing the 2 components of the bio-accelerant would be agitating a solution of sodium bicarbonate and a solution of sodium citrate. Another embodiment, the bio-accelerant is prepared by agitating sodium bicarbonate, and adipic acid, with a solution of sodium hydroxide. The bio-accelerants of the present application may be prepared using any method known to be useful to those of ordinary skill in the art as long as it results in an aqueous solution or suspension of the subject salts in a carrier. Preferably, the carrier is water.

For the purposes the present application, the term “admixture” means a composition having one or more phases wherein the components of the admixture are in contact with each other. For example, the term “aqueous admixture of organic compounds” means organic compounds in solution or suspension or present as a flock and/or sludge in water.

According to the process of the present application, the bio-accelerant is preferably prepared using only one material selected from each of the groups described above. Naturally, there may be some amount of naturally occurring “contaminants” that may be one of those listed above. For example, sodium carbonate and sodium bicarbonate exist in equilibrium. Nevertheless, desirably, the compounds used to form the bio-accelerant have only an immaterial amount of other compounds from the subject groups. For the purposes the present application, an immaterial amount would be 10% or less.

The bio-accelerants of the present application are preferably employed as salts. Some of the components are salts at virtually all pHs, such as sodium nitrate. Others though, such as sodium citrate, sodium adipate, are effective at pHs sufficiently high that they are present in the aqueous admixtures as salts rather than acids.

In one embodiment, the bio-accelerants of the application are introduced into the aqueous admixture of organic compounds at a concentration of from about 5 parts per million to about 25,000 parts per million. In another embodiment, the bio-accelerants are introduced into the aqueous admixture of organic compounds at a concentration of from about 50 parts per million to about 2,500 parts per million. In still another embodiment, the bio-accelerants are introduced into the aqueous admixture of organic compounds at a concentration of from about 100 parts per million to about 500 parts per million.

While it may be desirable to employ the bio-accelerants as liquids, it may be even more desirable to prepare the bio-accelerants as solids to reduce shipping costs. While most of the compounds useful with the present application are very safe, care should be used when dealing with oxidizing compositions. For example, extra care should be employed when using sodium hypochlorites or any of the other hypochlorites salts.

In one embodiment, the bio-accelerants useful with the process of the present application may be employed as a pill, pellet, capsule or brick. When employed as a capsule, the bio-accelerant is enclosed within a water-soluble container. In the other applications, the bio-accelerant is mixed with a binder and compressed. Some of the compounds useful for preparing the bio-accelerants of the application may be more compatible with solid applications than others. For example, citric acid is readily formed into a solid form as compared to other possible components.

Any binder known to be useful to those of ordinary skill in the art to bind together the components of the application may be employed with the process of the present application.

When preparing the bio-accelerants useful with the process of the present application, it may be economically desirable to use the least expensive cations. For example, in most cases it would be desirable to use sodium to form the salts but use of other alkali metals is within the scope of the claims of the present application. So, preferably, the cation will be sodium. In other embodiments, the cation can be potassium or lithium. Use of other alkali metals is probably prohibitively expensive in practice but still within the scope of the claims of the present application.

The bio-accelerants of the present application are prepared by admixing a first compound selected from the group consisting of alkali metal formates, alkali metal acetates, alkali metal malonates, alkali metal nitrates, alkali metal adipates, alkali metal salts of propane-1,2,3-tricarboxylic acid, or alkali metal citrates; and a second compound selected from the group consisting of: alkali metal carbonates, alkali metal bicarbonates, alkali metal dimethyl carbonates, or alkali metal hypochlorites. The ratio of the first compound to the second compound may be from about 1:9 to about 9:1. In some embodiments, the ratio is from about 1:4 to about 4:1. In still other embodiments, the ratio may be about 1:1.

In most instances, the bio-accelerants useful with the process of the application may be employed by introducing them directly into the material to be treated. For example, in a septic tank application, the bio-accelerant may be introduced directly without further modification. However, in some situations, it may be desirable to further augment the bio-accelerant with additional components to add additional functionality.

For example, when treating a system that is substantially sterile, it may be desirable to add a bacteria culture. Sometimes, depending upon the end-use, the bacterial culture can be selected to be specifically useful for that end-use. Such bacteria are commercially available.

While the components used to prepare the bio-accelerants of the application are desirably salts, in some applications, the acid form of the components may be used. For the purposes of the present application and for claiming purposes, the acid form of the salts claimed are within the scope of the claim even though not expressly listed.

The bio-accelerants useful with the process of the present application may be employed with aqueous admixtures of organic compounds that are either oxygen-rich or oxygen depleted. End-use applications where the embodiments of the invention may be applied include, but are not limited to:
Septic Tanks cleanup and maintenance (primary target currently)
Septic odor prevention
Animal waste lagoons
   Poultry
   Cattle
   Sheep
   Goats
   Hogs
Municipal wastewater treatment plants
Hydrocarbon spill remediation and well head area clean-up
Oil spot removal from concrete
RVs and travel trailers
Campground toilet facilities
H2S reduction in situations where bacteria are causing the production of the poisonous gas—H₂S
Clean up of downhole hydrocarbons in disposal wells
Removal of paraffin in downhole and/or surface equipment in the oil field
Clean up of “bad” tank bottoms in the oil field
Porta-can treatments
Hotel and resort waste systems
Cruise ships waste treatment
Organic waste treatment in foreign slums (where no wastewater treatment facilities exist—possibly 70% of the world population)
Bio-gas generation
Landfill operations

### Example

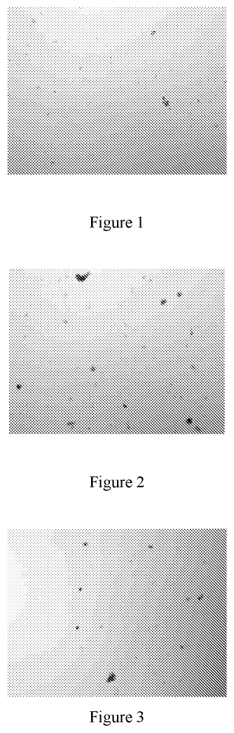

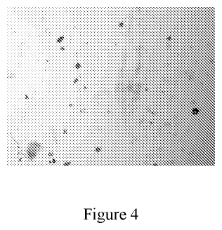

A test media was prepared by admixing chlorine free water, raw sugar, and a dry bacteria culture. The media was used to prepare a test sample and a control. The test sample was treated with a mixture of sodium nitrate and sodium bicarbonate. A drop of material was taken from the control after one hour and viewed under a microscope. FIG. 1 is a photomicrograph of the control after one hour. FIG. 2 is a photomicrograph of a drop of material taken from the test sample after one hour. FIG. 3 is a photomicrograph of the control after one day. FIG. 4 is a photomicrograph of this test sample after one day.

It is clear by viewing the photomicrographs that the bio-accelerant dramatically increased the size and number of bacteria colonies as compared to the control.

1. A process for accelerating biological decomposition of organic compounds comprising: introducing a bio-accelerant into an aqueous admixture of the organic compounds wherein the bio-accelerant comprises:
a first compound selected from the group consisting of, alkali metal formates, alkali metal acetates, alkali metal malonates, alkali metal nitrates alkali metal adipates, alkali metal salts of propane-1,2,3-tricarboxylic acid, and alkali metal citrates; and
a second compound selected from the group consisting of: alkali metal carbonates, alkali metal bicarbonates, alkali metal dimethyl carbonates, and alkali metal hypochlorites.

2. The process of claim 1 wherein the first compound is sodium formate and the second compound is sodium carbonate.

3. The process of claim 1 wherein the first compound is sodium formate and the second compound is sodium bicarbonate.

4. The process of claim 1 wherein the first compound is sodium formate and the second compound is sodium carbonate.

5. The process of claim 1 wherein the first compound is sodium nitrate and the second compound is sodium bicarbonate.

6. The process of claim 1 wherein the first compound is sodium citrate and the second compound is sodium carbonate.

7. The process of claim 1 where the bio-accelerant is in the form of a liquid or powder.

8. The process of claim 1 where the bio-accelerant is in the form of a pill, pellet, capsule, or brick.

9. The process of claim 7 wherein the first and second compounds are admixed to form the bio-accelerant, and the bio-accelerant is introduced into the admixture at a concentration of from about 5 parts million to about 25,000 parts million.

10. The process of claim 9 further comprising including a bacteria culture selected for an intended end-use in the bio-accelerant.

11. The process of claim 2 where the bio-accelerant is in the form of a liquid or powder.

12. The process of claim 3 where the bio-accelerant is in the form of a liquid or powder.

13. The process of claim 4 where the bio-accelerant is in the form of a liquid or powder.

14. The process of claim 5 where the bio-accelerant is in the form of a liquid or powder.

15. The process of claim 6 where the bio-accelerant is in the form of a liquid or powder.

16. The process of claim 2 where the bio-accelerant is in the form of a pill, pellet, capsule, or brick.

17. The process of claim 3 where the bio-accelerant is in the form of a pill, pellet, capsule, or brick.

18. The process of claim 4 where the bio-accelerant is in the form of a pill, pellet, capsule, or brick.

19. The process of claim 6 wherein the first and second compounds are admixed to form the bio-accelerant, and the bio-accelerant is introduced into the admixture at a concentration of from about 5 parts million to about 25,000 parts million.

20. The process of claim 7 wherein the first and second compounds are admixed to form the bio-accelerant, and the bio-accelerant is introduced into the admixture at a concentration of from about 5 parts million to about 25,000 parts million.
